(19) United States
(12) Patent Application Publication
(10) Pub. No.: US 2011/0148424 A1
(43) Pub. Date: Jun. 23, 2011

(54) APPARATUS FOR ESTIMATING BATTERY STATE OF HEALTH

(75) Inventors: YI-HSIEN CHIANG, Hualien County (TW); Wu-Yang Sean, Hsinchu City (TW)

(73) Assignee: Industrial Technology Research Institute, Hsinchu (TW)

(21) Appl. No.: 12/956,077

(22) Filed: Nov. 30, 2010

(30) Foreign Application Priority Data
Dec. 22, 2009 (TW) 098144212
Jul. 22, 2010 (TW) 099124165

(51) Int. Cl. G01N 27/416

(52) U.S. Cl. 324/427

(57) ABSTRACT

An apparatus for estimating state-of-health (SOH) of a battery is disclosed, which comprises: a measurement unit, for measuring a working current, a working voltage and a working temperature of the battery; an observer unit, for observing voltages at an output end and RC parallel circuits of the battery; an adaptive algorithm unit, for updating parameters of the battery; an internal voltage estimation unit, for estimating the internal voltages of the RC parallel circuits; an open-circuit voltage (OCV) estimation unit, for estimating static open-circuit voltage of the battery; a SOH estimation unit, for estimating an SOH of the battery; and a state-of-charge (SOC) estimation unit, for estimating a SOC of the battery.

### TECHNICAL FIELD

The present disclosure relates to a battery state-of-health (SOH) estimation apparatus, and more particularly, to an apparatus capable of basing upon an adaptive algorithm to perform a real-time measurement and estimation for determining the SOH of a battery according to an internal resistance of the battery estimated by the use of a working voltage and a working current that are inputted into the apparatus, and thereby, capable of being used for monitoring the status of the battery in a continuous manner. The apparatus can be adapted for a variety of batteries, including lead-acid batteries, nickel-metal hydride batteries and lithium-ion batteries.

### TECHNICAL BACKGROUND

In applications where secondary batteries are used as a power source it can be desirable to know state-of-charge (SOC) and state-of-health (SOH) of the batteries. For instance, an effective vehicular power management will require accurate knowledge of battery state, including SOC and SOH. That is, in electric vehicles, it is important to know the SOC of the batteries in order to prevent vehicle strandings and to ensure that the full range of the vehicle is exploited. It is also useful to know the SOH about the batteries to predict when the batteries need replacing. Generally, the status of a battery pack in an electric vehicle is managed and monitored by a battery management system (BMS), which is designed to perform tasks including charge/discharge protection, battery voltage equalization, and so on. However, since the battery pack is going to be subjected to a varying load during engine cranking and the differences battery cells in the battery pack may have difference characteristics in performance, it is difficult to achieve an accurate and robust battery SOC and SOH information for battery packs used in electric vehicle. For the SOC information which is comparatively easier to measure, the error may reach as high as 5% to 10%, not to mention the error in SOH measurement. Therefore, a need still exists to have an apparatus capable of monitoring and measuring SOH information of a battery in a simple and reliable manner on a real time basis under all operating conditions with the battery installed in the vehicle.

As SOH does not correspond to a particular physical quality, there is no consensus in the industry on how SOH should be determined. Conventionally, the SOH is estimated and determined either by an established function of state-of-health, or by a BMS which use battery parameters to derive an arbitrary value for the SOH in a manner that the BMS defines an arbitrary weight for each of the parameter's contribution to the SOH value. Nevertheless, the establishment of the former SOH function depends upon the analysis and conclusion resulting from a massive amount of laboratory works and battery performance experiments, which not yet has definite consensus in the industry and thus may cause serious doubt to the accuracy of SOH estimation. The latter involves the measurement of those battery parameters, but is currently only available for lead-acid batteries and nickel-metal hydride batteries, as those disclosed in U.S. Pat. No. 6,456,988, entitled “Method for determining state-of-health using an intelligent system”, in U.S. Pat. No. 6,885,951, entitled “Method and device for determining the state of function of an energy storage battery”, and in U.S. Pat. No. 6,465,512, entitled “System and method for determining batter state-of-health”. However, there is no such study relating to the determining of SOH for lithium-ion batteries.

Therefore, it is in need of a trustworthy battery SOH estimation apparatus and method for enabling a user to obtain accurate dynamic information relating to battery status.

### TECHNICAL SUMMARY

The present disclosure relates to a battery state-of-health (SOH) estimation apparatus, capable of basing upon an adaptive algorithm to perform an off-line measurement for determining the SOH of a battery according to an internal resistance of the battery estimated by the use of a working voltage and a working current that are inputted into the apparatus, and thereby, capable of being used for monitoring the status of the battery in a continuous manner without the use of additional electronic devices which may be expensive such as internal resistance meter. The apparatus can be adapted for a variety of batteries, including lead-acid batteries, nickel-metal hydride batteries and lithium-ion batteries.

The present disclosure provides a battery SOH estimation apparatus, comprising:
a measurement unit, connected to an output end of a battery, provided for measuring a working current, a working voltage and a working temperature of the battery and thus outputting a current signal, a voltage signal and a temperature signal accordingly and correspondingly;
an observer unit, for observing voltages at the output end and RC parallel circuits of the battery while correspondingly outputting a voltage-error signal relating to the output end, a battery RC internal voltage signal, and a differential current signal;
an adaptive algorithm unit, for outputting at least one parameter updating signal so as to enable the updating of corresponding parameters of the battery;
an internal voltage estimation unit, for estimating internal voltages of the RC parallel circuits of the battery while correspondingly outputting an internal voltage estimation signal;
an open-circuit voltage (OCV) estimation unit, for estimating static open-circuit voltage of the battery while correspondingly outputting an open-circuit voltage signal;
a state-of-health (SOH) estimation unit, for estimating an SOH of the battery while correspondingly outputting a battery SOH signal; and
a state-of-charge (SOC) estimation unit, for estimating an SOC of the battery.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a circuit diagram showing the architecture of a battery state of health (SOH) estimation apparatus according to the first embodiment of the present disclosure.

FIG. 2 is a circuit diagram of a battery.

FIG. 3 is a graph illustrating the relationship between open-circuit voltage (OCV) and depth-of-discharge (DOD) of the battery used in the present disclosure.

FIG. 4 is a graph illustrating the relationship between SOH and internal resistance of the battery used in the present disclosure.

FIG. 5 is a chart depicting the calculation process performed in the first embodiment of the present disclosure.

FIG. 6 to FIG. 9 are graphs depicting curves of various circuit simulation and testing under different operation conditions.

FIG. 10 to FIG. 12 are curves representing the estimation results of different battery parameters used in the present disclosure.

FIG. 13 to FIG. 14 are schematic diagrams showing two different applications of a battery state-of-health (SOH) estimation apparatus according to the first embodiment of the present disclosure.

FIG. 15 is a circuit diagram showing the architecture of a battery state of health (SOH) estimation apparatus according to a second embodiment of the present disclosure.

FIG. 16 is a flow chart depicting a calculation process performed in the battery state-of-health (SOH) estimation apparatus of the second embodiment.

FIG. 17 is a diagram showing the relationship between power and time of the present disclosure under a standard driving mode.

FIG. 18 is a graph illustrating the relationship between open-circuit voltage (OCV) and 2%, 4%, 6%, 8% DOD in the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

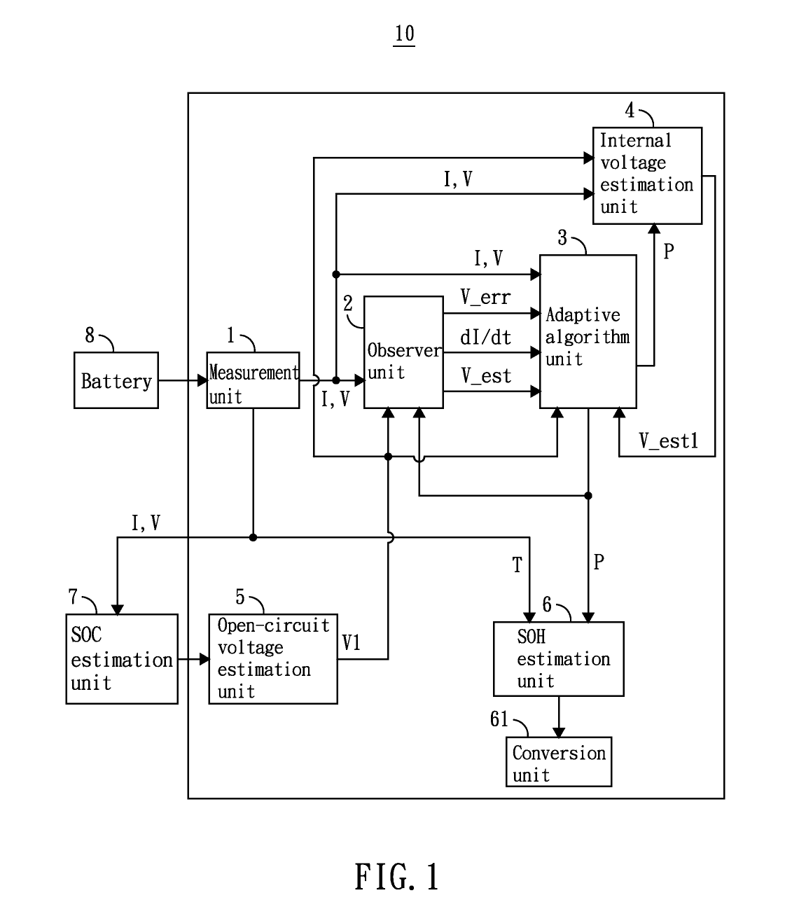

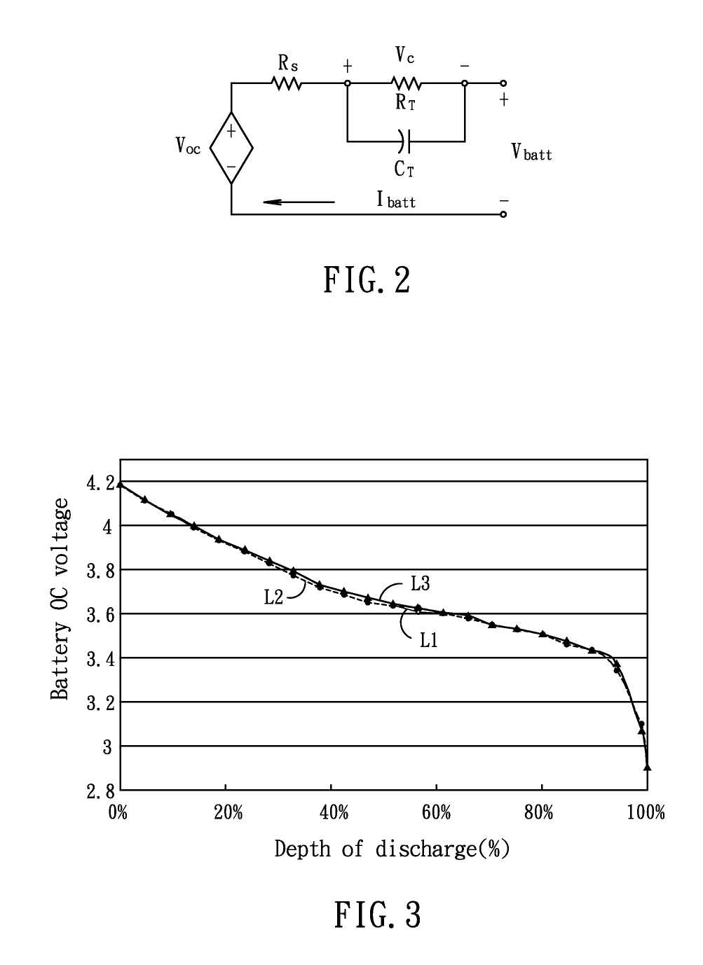

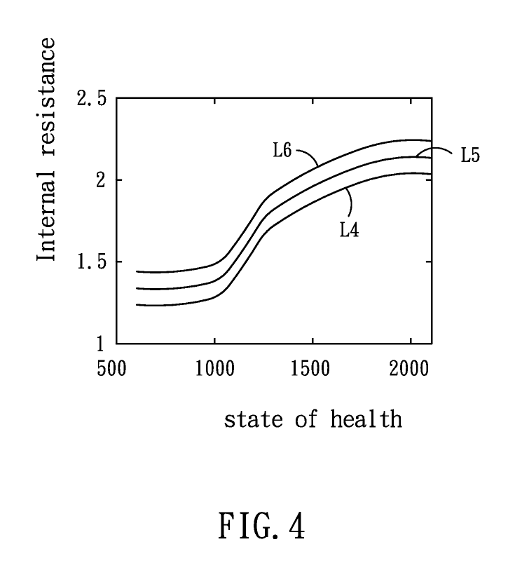

Please refer to FIG. 1, which is a circuit diagram showing the architecture of a battery state-of-health (SOH) estimation apparatus according to an embodiment of the present disclosure. In FIG. 1, the battery SOH estimation apparatus 10 comprises: a measurement unit 1, an observer unit 2, an adaptive algorithm unit 3, an internal voltage estimation unit 4, an open-circuit voltage (OCV) estimation unit 5, a state-of-charge (SOC) estimation unit 7 and a state-of-health (SOH) estimation unit 6, in which the measurement unit 1 is connected to an output end of a battery 8. Please refer to FIG. 2, which is an equivalent circuit diagram of a battery. As shown in FIG. 2, the parameters of the battery 8 are described as following:
V_{OC}: representing an OCV of the battery 8, which can be calculated and obtained using the result of the SOC estimation from the SOC estimation unit 7 with respect to a database containing information relating to the relationship between battery SOC and a battery OCV. As for the database containing information relating to the relationship between battery SOC and battery OCV, please refer to an exemplary graph illustrating the relationship between OCV and depth-of-discharge (DOD) of the battery, as shown in FIG. 3. It is noted that the curves representing the relationship between OCV and DOD will be different with different batteries. In FIG. 3, the curves L1, L2, L3 represent respectively the statuses of the battery 8 at a room temperature, at 25° C. and at 38° C., which are disposed about overlapping with each other. Since the relationship between the SOC and DOD is that: SOC=1−DOD, and thereby, the SOC of the battery can be obtained;
V_{batt}: representing a working voltage of the battery 8, which can be measured by the measurement unit 1;
I_{batt}: representing a working current of the battery 8, which can be measured by the measurement unit 1;
V_{C}: representing the voltage of the battery RC parallel circuit, which is obtained from the internal voltage estimation unit 4;
R_{S}, R_{T}, C_{T}: representing the primary parameters of the battery that the SOH estimation apparatus 10 is designed to be estimated;
\hat{V}_{batt}: representing the voltage obtained from the observation of the observer unit 2;
\hat{V}_{C}: representing the voltage of the battery RC parallel circuit obtained from the internal voltage estimation unit 4.

As shown in FIG. 1, the measurement unit 1 is provided for measuring a working current, a working voltage and a working temperature of the battery 8 and thus outputting a current signal I, a voltage signal V and a temperature signal T accordingly and correspondingly while transmitting the current signal I and the voltage signal V to the observer unit 2, the adaptive algorithm unit 3, the internal voltage estimation unit 4 and the SOC estimation unit 7, and the temperature signal T to the SOH estimation unit 6 for SOH estimation.

The observer unit 2, being electrically connected to the measurement unit 1, is used for observing voltages at the output end of the battery 8, i.e. \hat{V}_{batt} whereas the observation of the observer unit 2 is performed by the use of a first-order differential state equation relating to the battery 8. Accordingly, the observer unit 2 is enabled to receive the current signal I, the voltage signal V, both being transmitted from the measurement unit 1, and the parameter updating signal P, being transmitted from the adaptive algorithm unit 3, and the OCV signal V1 from the OCV estimation unit 5, while performing a calculation basing upon those received signals so as to obtain and thus output a voltage-error signal relating to the output end V_err, a voltage estimation signal relating to the output end V-est, and a differential current signal dI/dt.

The adaptive algorithm unit 3, being electrically connected to the measurement unit 1, is enabled to observe and measure the current signal I, the voltage signal T, both being transmitted from the measurement unit 1, and the OCV signal V1 from the OCV estimation unit 5, and the voltage-error signal l V_err, the voltage estimation signal V_est, and the differential current signal dI/dt, all being outputted from the observer unit 2, and an internal voltage estimation signal V_est1 from the internal voltage estimation unit 4 so as to perform the updating of corresponding parameters of the battery 8 accordingly, such as the R_{S}, R_{T}, C_{T} shown in FIG. 2. Moreover, the adaptive algorithm unit 3 is used for outputting at least one parameter updating signal P, which is being transmitted to the internal voltage estimation unit 4 where it is used in an estimation operation and also being further transmitted to the SOH estimation unit 6 for SOH estimation.

The internal voltage estimation unit 4, being electrically connected to the measurement unit 1, the observer unit 2 and the adaptive algorithm unit 3, is enabled to received the current signal I, the voltage signal V, both transmitted from the measurement unit 1, and the parameter updating signal P from the adaptive algorithm unit 3, and the OCV signal V1 from the OCV estimation unit 5 for performing an internal voltage estimation upon the RC parallel circuit in the battery 8, as that shown in FIG. 2. Moreover, for speeding up the parameter convergence in the RC parallel circuit and also improving accuracy, a series resistance parameter R_{S} is used in the internal voltage estimation of the RC parallel circuit since the series resistance parameter R_{S} that is highly sensitive to differential current and is going to converge rapidly. That is, when the series resistance parameter R_{S} is converged, the result of the internal voltage estimation relating to the signal of series resistance parameter R_{S} will be exactly the same as the actual voltage so that the estimated result of the series resistance parameter R_{S} can be used in a comparison with the estimation from the internal voltage estimation unit 4 so that the parameter convergence of the RC parallel circuit is accelerated. Thereafter, the internal voltage estimation unit 4 is enabled to issue an internal voltage estimation signal V_est1 which is being transmitted to the adaptive algorithm unit 3 for parameter updating.

The OCV estimation unit 5, being electrically connected to the observer unit 2, is enabled to use a database containing information relating to the relationship between battery SOC and a battery OCV, as the graph of FIG. 3, and the SOC of the battery obtained from the SOC estimation unit 7 in a calculation for obtaining the static OCV V_{OC} of the battery 8, as shown in FIG. 2, while correspondingly outputting the OCV signal V1 to the observer unit 2, the adaptive algorithm unit 3 and the internal voltage estimation unit 4.

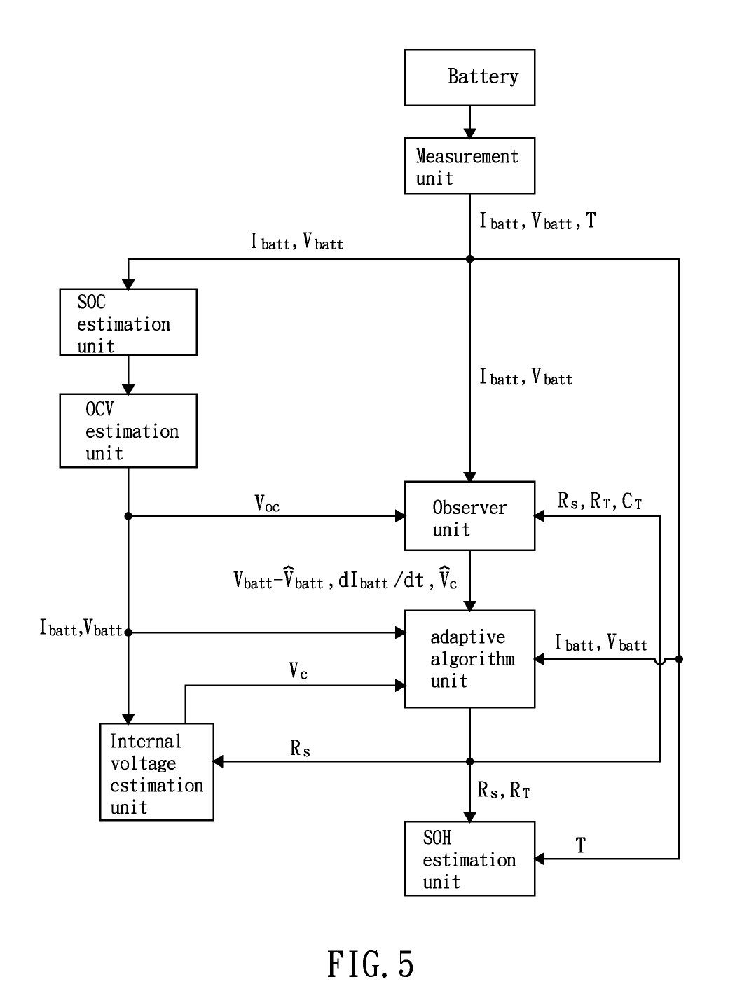

The SOH estimation unit 6, being electrically connected to the measurement unit 1, the observer unit 2 and the adaptive algorithm unit 3, is enabled to perform a battery SOH estimation upon the battery 8 according to the temperature signal T from the measurement unit 1, the parameter updating signal P from the adaptive algorithm unit 3, and the database containing information relating to the relationship between battery SOH and the variation of battery internal voltages, and thus correspondingly outputting a battery SOH signal. Please refer to FIG. 4, which is a graph illustrating the relationship between SOH and internal resistance of the battery used in the present disclosure. As shown in FIG. 4, the curves L4, L5, L6 represent respectively the statuses of the battery 8 at 45° C., at 35° C. and at 25° C., by which the SOH of the battery 8 can be estimated, In addition, the SOH estimation unit 6 is further coupled to a conversion unit 61, which is used for perform a conversion operation upon the battery SOH signal; and the conversion operation is an operation selected from the group consisting of: a unit conversion and a analog-to-digital conversion. Moreover, the conversion unit 61 is further coupled to a device selected from the group consisting of: a battery management system (BMS) and a display device, where the converted battery SOH signal is displayed.

The state-of-charge (SOC) estimation unit 7, being electrically connected to the measurement unit 1, the OCV estimation unit 5 and the SOH estimation unit 6, is used for estimating a SOC of the battery while transmitting the measured SOC to the OCV estimation unit 5 for OCV calculation.

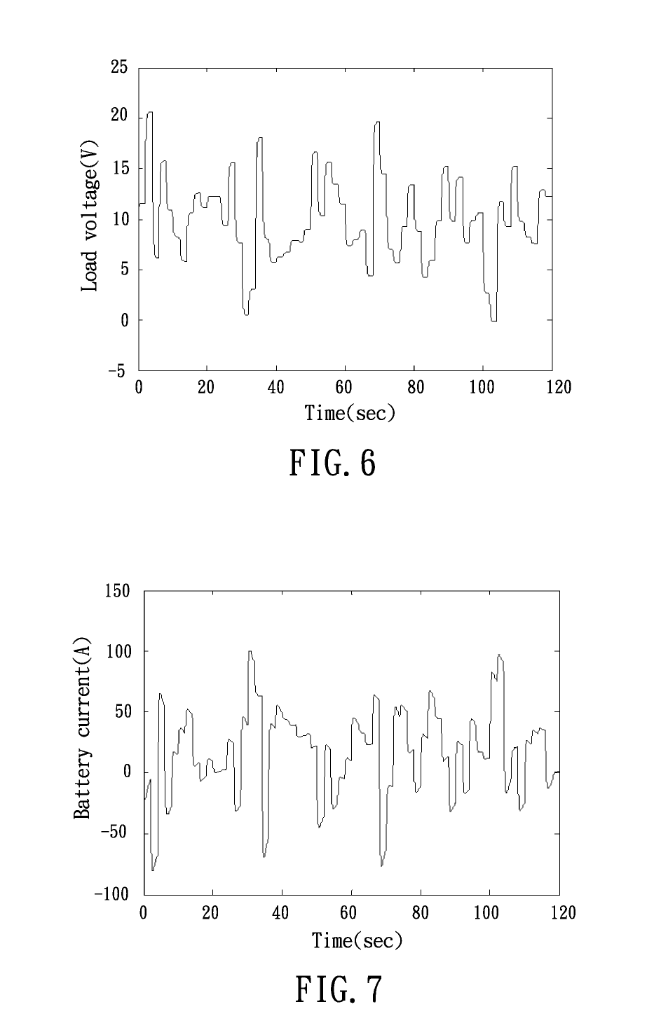

Concluding from the description relating to the battery SOH estimation apparatus of FIG. 1 and the battery model of FIG. 2, a chart depicting the calculation process performed in the present disclosure can be obtained, as shown in FIG. 5. Moreover, the parameter convergence of the battery SOH estimation apparatus 10 of the present disclosure can be confirmed according to the following equation:

$$\vert \frac{d {R}_{S}}{d t} \vert + \vert \frac{d {R}_{T}}{d t} \vert + \vert \frac{d {C}_{T}}{d t} \vert \leq δ$$

wherein, δ is a predefined small value

From the foregoing description, it is noted that the battery SOH estimation apparatus of the present disclosure uses parameters of a battery that are sensitive to the variation of the battery SOH as indicators for SOH estimation, so that the battery SOH estimation apparatus of the present disclosure is designed to perform an on-line estimation basing upon an adaptive algorithm for determining the SOH of a battery according to an internal resistance of the battery estimated by the use of a working voltage and a working current that are inputted into the apparatus. Although the internal resistance of a battery can be obtained directly by the measurement of a cell internal resistance meter when the battery is static, but when the battery is in use, i.e. in dynamic state, such battery's internal resistance is a variable that is going to vary with the temperature and other working conditions of the battery. Therefore, the battery SOH estimation apparatus of the present disclosure applies the adaptive algorithm for enabling the same to measure internal resistances of a battery in static state and also in dynamic state. The use of adaptive algorithm in internal resistance estimation is featuring in that: with the knowledge of the transient working current and transient working voltage of a battery in dynamic state, the adaptive observer, as the observer unit 2 of FIG. 2, is able to perform an automatic adaptive calibration process so as to obtain a correct internal resistance of the battery. As shown in FIG. 1, the working current and a working voltage of the battery 8 that are obtained from the measurement unit 1 are transmitted to the adaptive algorithm unit 3, at which the condition of convergence is defined and used as the core for controlling the operation of the apparatus. Also, the measured working current and working voltage are filtered and normalized by the observer unit 2, and the internal voltage estimation unit 4 is used for speed up the equivalent circuit parameter convergence so as to obtain a transient internal resistance. The results of the observer unit 2 and the internal voltage estimation unit 4 are then being transmitted to the adaptive algorithm unit 3. Since both the observer unit 2 and the adaptive algorithm unit 3 will require OCV of the battery so as to function accordingly, it is required to have a function of OCV or an OCV lookup table, as the curve shown in FIG. 3, that can be used for obtaining the OCV according to the SOC of the battery 8 that is estimated by the OSC estimation unit 7. Finally, if the results from the cooperation of the observer unit 2 and the adaptive algorithm unit 3 is converged, it is used as the internal resistance as it is being the parameter sensitive to the SOH variation, which can be applied in a database containing the relationship between SOH and internal resistance of the battery, as the one shown in FIG. 4, so that the SOH of the battery can be obtained.

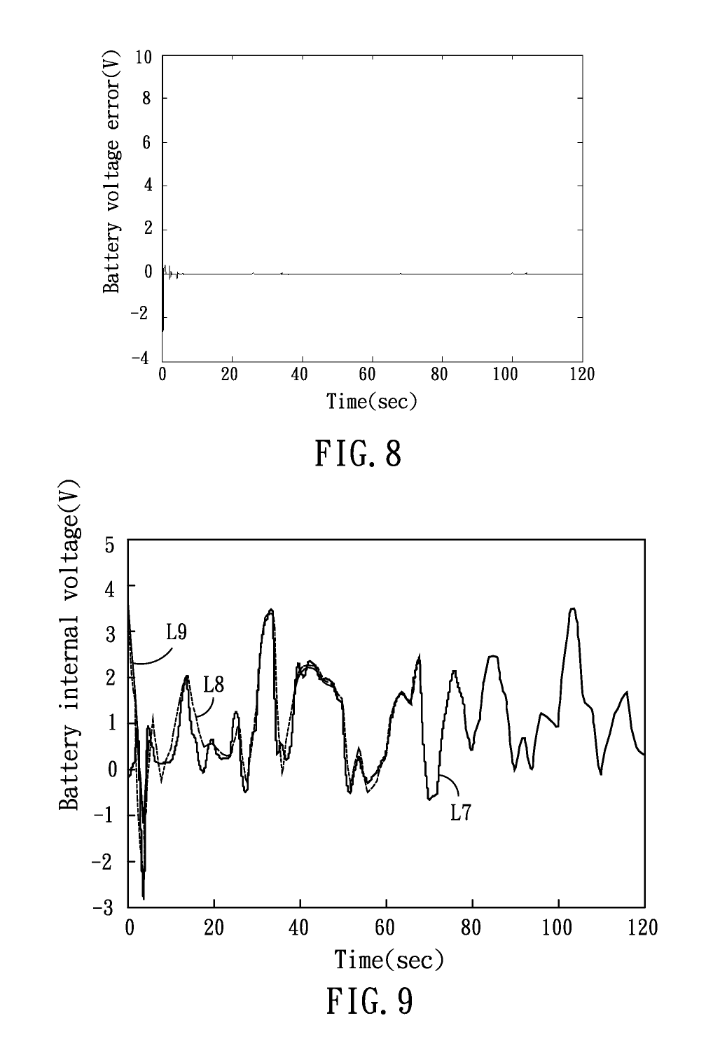

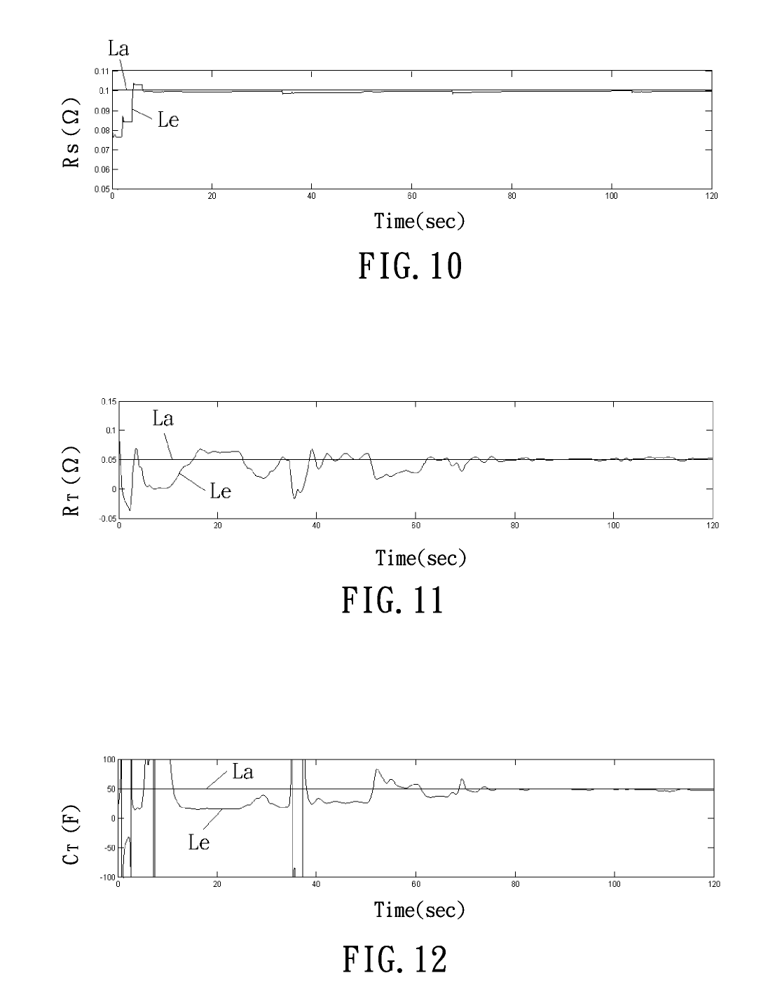

It is noted that the effectiveness of the apparatus of the present disclosure can be verified by those curves shown in FIG. 6 to FIG. 9, and also those shown in FIG. 10 to FIG. 12. Wherein, FIG. 6 shows a curve depicting the load voltage variation of a battery; FIG. 7 shows a curve depicting the variation of battery working current; FIG. 8 represents estimated load voltage error; and FIG. 9 represent estimated capacity voltage whereas the curve L7 depicts the estimated internal voltage in the observer unit 2, the curve L8 depicts the internal voltage estimated from the internal resistance R_{S} of the adaptive algorithm unit 3, and the curve L9 depicts true voltage of the battery 8. In addition, FIG. 10 represents the parameter estimation of the series resistance parameter R_{S}, FIG. 11 represents the parameter estimation of resistance parameter R_{T}, and FIG. 12 represents the parameter estimation of the capacity parameter C_{T}, whereas the curve La depicts the variation of true capacity parameter and the curve Le depicted the variation of estimated capacity parameter. As the circuit simulation of the present disclosure shown in FIG. 6 to FIG. 9, the voltage inputted into the apparatus is varying dramatically and the current as well, however, as indicating in the load voltage error curve shown in FIG. 8 that it is converged rapidly after being treated by the control of the adaptive algorithm that it is converged within 20 seconds and at the same time that an accurate result of parameter estimated can be achieved. It is noted from FIG. 9 that the apparatus of the present disclosure is actually capable of calibrating itself automatically and effectively. From FIG. 10 to FIG. 12, it is noted that the error is within 10%.

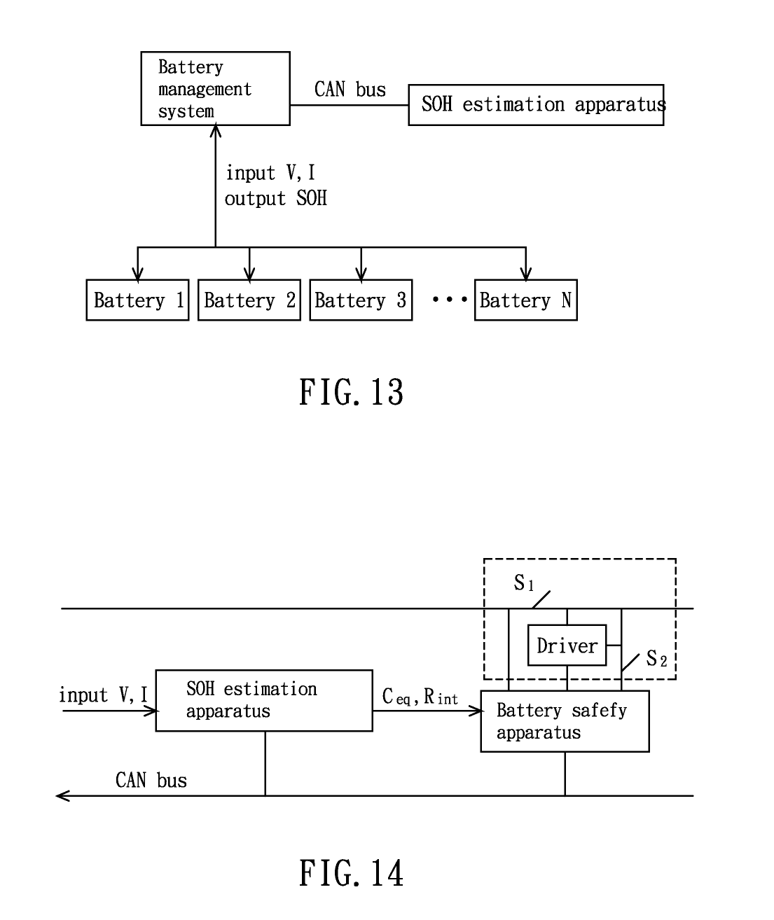

Please refer to FIG. 13 and FIG. 14, which are schematic diagrams showing two different applications of a battery state of health (SOH) estimation apparatus of the present disclosure. As shown in FIG. 13, the operation of the battery SOH estimation apparatus can be enabled by the control of a BMS through the transmission of a controller area network (CAN bus), in which the working voltages V and the working currents I are measured by the BMS and then being transmitted to the battery SOH estimation apparatus to be used for SOH estimation, and then the estimated SOH is transmitted back to the BMS where it is provided to a driver as reference. Moreover, the e battery SOH estimation apparatus of the present disclosure is able to connect and work in combination of other battery safety apparatuses. Thereby, the parameter that is sensitive to SOH and is estimated by the battery SOH estimation apparatus, such as the internal resistance, can be provided to those battery safety apparatuses as indicator of abnormality determination and control so as to improve the operation safety of the battery.

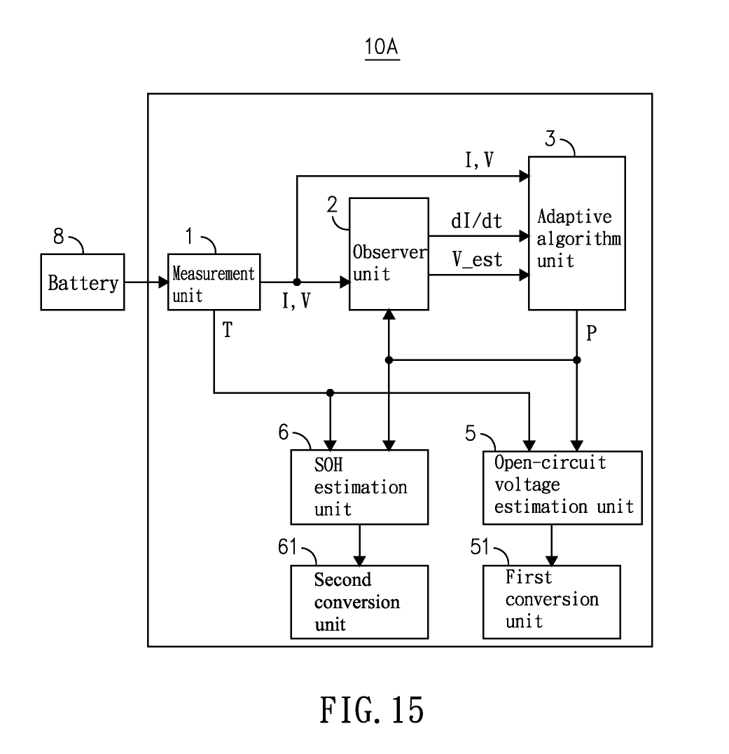

The battery SOH estimation apparatus disclosed in the first embodiment of FIG. 1 is comprised of: a measurement unit 1, an observer unit 2, an adaptive algorithm unit 3, an internal voltage estimation unit 4, an OCV estimation unit 5, a SOH estimation unit 6 and a SOC estimation unit 7. The calculation process performed in the battery SOH estimation apparatus of the first embodiment uses a SOC obtained from an external device in an OCV estimation and then feeds the result of the OCV estimation to the observer unit and the adaptive algorithm unit to be used for SOH estimation. Nevertheless, the present disclosure is not limited thereby that the battery SOH estimation apparatus can be achieved using different configuration and calculation process, as shown in a second embodiment of FIG. 15.

Please refer to FIG. 15, which is a circuit diagram showing the architecture of a battery state of health (SOH) estimation apparatus according to a second embodiment of the present disclosure. As shown in FIG. 15, the SOH estimation apparatus 10A comprises: a measurement unit 1, an observer unit 2, an adaptive algorithm unit 3, an OCV estimation unit 5, and a SOH estimation unit 6; in which the measurement unit 1 is connected to an output end of a battery 8, and the OCV estimation unit 5 is connected to a first conversion unit 51 while the SOH estimation unit 6 is connected to a second conversion unit 61. It is noted that the measurement unit 1, the observer unit 2, the adaptive algorithm unit 3, the OCV estimation unit 5, the SOH estimation unit 6 and the second conversion unit 61 are the same as those used in the first embodiment of FIG. 1. The difference between the second embodiment and the first embodiment is that: the internal voltage estimation unit 4 and the SOC estimation unit 7 that are used in the first embodiment are not configured in the battery SOH estimation apparatus of the second embodiment, and there is an additional first conversion unit 51 being connected to the OCV estimation unit 5. That is, the configuration of the second embodiment is simplified comparing with the first embodiment, and thus the calculation process performed in the second embodiment for SOC and SOH estimation is also being simplified.

As shown in FIG. 15, the measurement unit 1 is provided for measuring a working current, a working voltage and a working temperature of the battery 8 and thus outputting a current signal I, a voltage signal V and a temperature signal T accordingly and correspondingly while transmitting the current signal I and the voltage signal V to the observer unit 2, the adaptive algorithm unit 3, and the temperature signal T to the OCV estimation unit 5 and the SOH estimation unit simultaneously 6 for respectively performing a SOC estimation and a SOH estimation.

The observer unit 2, being electrically connected to the measurement unit 1, is used for observing voltages at the output end of the battery 8, i.e. \hat{V}_{batt}, whereas the observation of the observer unit 2 is performed by the use of a first-order differential state equation relating to the battery 8. Accordingly, the observer unit 2 is enabled to receive the current signal I, the voltage signal V, both being transmitted from the measurement unit 1, and the parameter updating signal P, being transmitted from the adaptive algorithm unit 3, while performing a calculation basing upon those received signals so as to obtain and thus output a voltage estimation signal relating to the output end V-est, and a differential current signal dI/dt.

The adaptive algorithm unit 3, being electrically connected to the measurement unit 1, is enabled to observe and measure the current signal I, the voltage signal T, both being transmitted from the measurement unit 1, and the voltage estimation signal V_est, and the differential current signal dI/dt, both being outputted from the observer unit 2, so as to perform the updating of corresponding parameters of the battery 8 accordingly. Moreover, the adaptive algorithm unit 3 is used for outputting at least one parameter updating signal P, which is being transmitted to the observer unit 2, the OCV estimation unit 5 and the SOH estimation unit 6 where it is used in a SOC estimation operation and a SOH estimation.

The OCV estimation unit 5, being electrically connected to the measurement unit 1, the observer unit 2 and the adaptive algorithm unit 3, is designed to base upon the temperature signal T from the measurement unit 1 and the parameter updating signal P from the adaptive algorithm unit 3 for calculating an OCV signal. As the OCV estimation unit 5 is further connected to a first conversion unit 51, the OCV signal is fed to the first conversion unit 51 for unit conversion or analog-to-digital conversion and then comparing with an built-in lookup table, as the one shown in FIG. 3, so as to obtain a corresponding SOC signal which can be displayed on a display device or a battery management system that is connected to the first conversion unit 51.

The SOH estimation unit 6, being electrically connected to the measurement unit 1 and the OCV estimation unit 5, is enabled to perform a battery SOH estimation upon the battery 8 according to the temperature signal T from the measurement unit 1, the parameter updating signal P from the adaptive algorithm unit 3, and the database containing information relating to the relationship between battery SOH and the variation of battery internal voltages, as the one shown in FIG. 4, and thus correspondingly outputting a battery SOH signal. In addition, the SOH estimation unit 6 is further coupled to a second conversion unit 61, which is used for perform a conversion operation upon the battery SOH signal; and the conversion operation is an operation selected from the group consisting of: a unit conversion and a analog-to-digital conversion. Moreover, the conversion unit 61 is further coupled to a device selected from the group consisting of: a battery management system (BMS) and a display device, where the converted battery SOH signal is displayed.

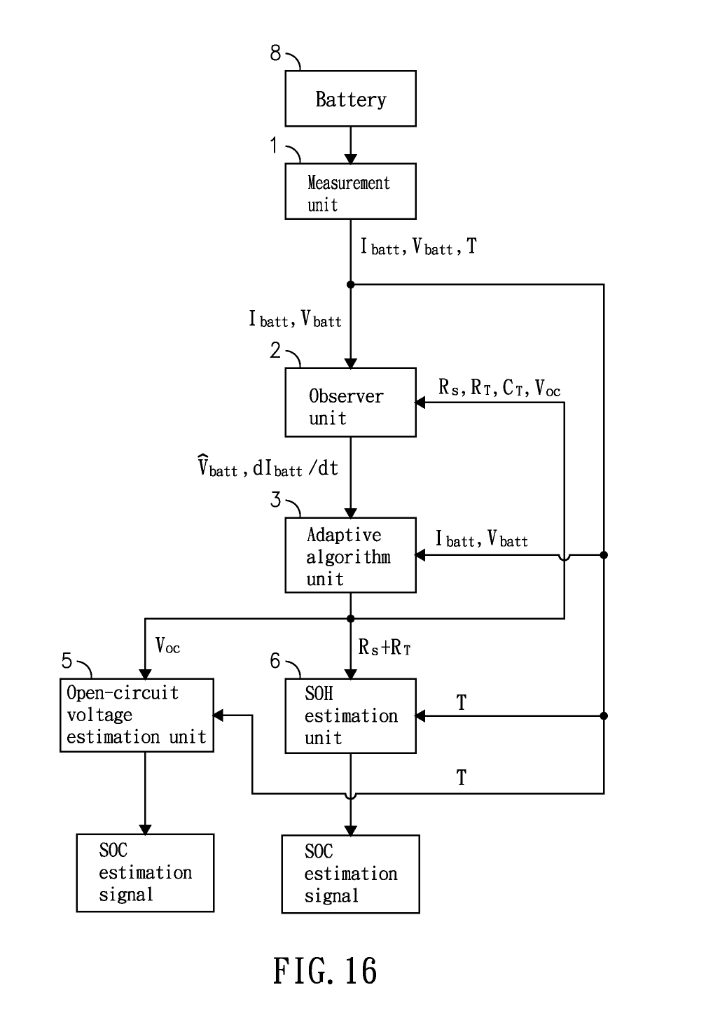

Concluding from the description relating to the battery SOH estimation apparatus 10A of FIG. 15 and the battery model of FIG. 2, a chart depicting the calculation process performed in battery SOH estimation apparatus 10A of FIG. 15 can be obtained, as shown in FIG. 16.

Comparing the second embodiment shown in FIG. 15 and the first embodiment shown in FIG. 1, it is noted that the difference between the two is that: the internal voltage estimation unit 4 and the SOC estimation unit 7 that are used in the first embodiment are not configured in the battery SOH estimation apparatus 10A of the second embodiment, and there is an additional first conversion unit 51 being connected to the OCV estimation unit 5, and thereby, the configuration of the second embodiment is simplified comparing with the first embodiment, and thus the calculation process performed in the second embodiment for SOC and SOH estimation is also being simplified, i.e. the battery SOH estimation apparatus 10 of the first embodiment uses a SOC obtained from an external device to perform an OC voltage estimation and thus feeds the result of the OCV estimation to the observer unit and the adaptive algorithm unit for SOH estimation; while OCV in the battery SOH estimation apparatus 10A of the second embodiment is being used as one of the battery parameters and the OCV estimation is performed in the adaptive algorithm units to be used in a consultation to a lookup table for obtaining a corresponding SOC.

It is noted that the effectiveness of the battery SOH estimation apparatus 10A of the second embodiment as well as its calculation process of FIG. 16 can be verified in an experiment described hereinafter.

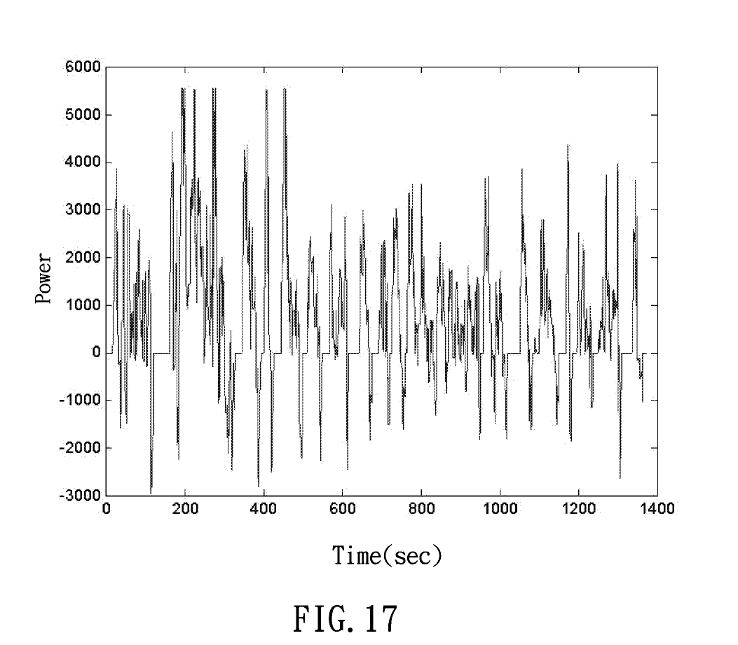

In the experiment, the battery SOH estimation apparatus 10A is fitted in an electric vehicle to be used for estimating the SOC during the driving of the electric vehicle under FTP-75 (Federal test procedure) standard driving mode. Please refer to FIG. 17, which is a diagram showing the relationship between power and time of a 70V vehicle battery set under the standard driving mode. In FIG. 17, those portions of positive values indicate that the battery set is discharging for driving the electric vehicle, and the those of negative values indicate that the electric vehicle is braking.

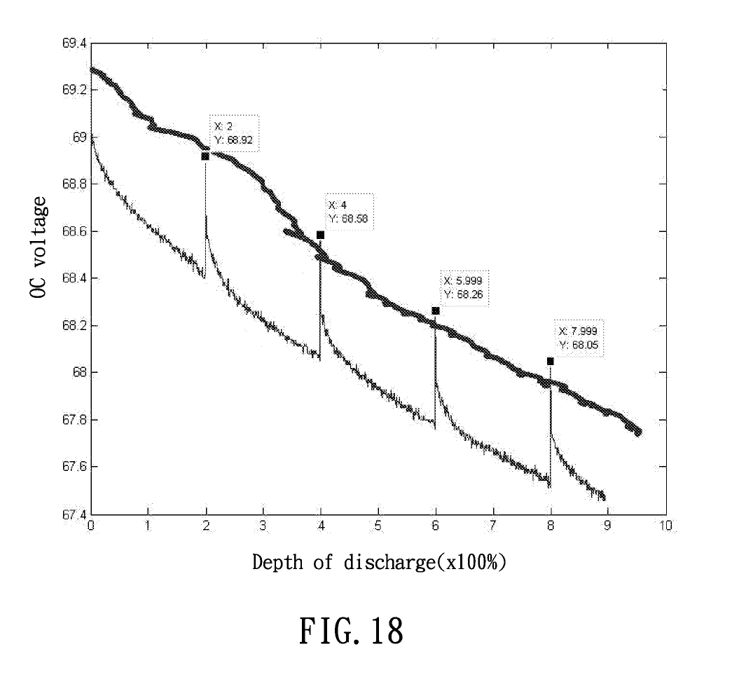

The coarse dotted line illustrated in FIG. 18 represents the OCVs estimated under the aforesaid driving mode and their corresponding discharge of depth (DOD), whereas DOD=100%−SOC. As shown in FIG. 18, there are points that are repeated at the same DOD, which are caused by estimation error in charging/discharging. However, actual OCVs are obtained thirty minutes after the battery is enabled to discharge in 2% DOD, i.e. after the dropped the voltage is bounced back upwardly, and repeating the aforesaid process four time so as to obtain the relationship between open-circuit voltage (OCV) and 2%, 4%, 6%, 8% DOD, as the thin solid line shown in FIG. 18. Comparing the OCVs of 2%, 4%, 6%, 8% DOD shown in FIG. 18, it is noted that the OCV estimation error is smaller than 1% DOD, that is, the SOC estimation error is smaller than 1%, so that the estimation accuracy and the feasibility of the battery SOH estimation apparatus of the second embodiment can be proven to be satisfactory.

To sum up, as the adaptive algorithm used in the battery SOH estimation apparatus of the present disclosure is a kind of dynamic estimation algorithm, capable of estimating and determining the parameters of a working battery according to varying signals battery measured from the working battery, and thereby, capable of being used for monitoring the status of the battery in a continuous manner. As the battery SOH estimation apparatus of the present disclosure is able of perform a full-scale estimation upon battery parameters including the internal resistance and capacity of the battery, the SOH of the battery can be estimated with higher accuracy comparing with prior arts.

Moreover, the battery SOH estimation apparatus of the present disclosure can be adapted for a variety of batteries, including lead-acid batteries, nickel-metal hydride batteries and lithium-ion batteries, without having to involving itself in complex circuit or firmware adjustment.

As the battery SOH estimation apparatus of the present disclosure is designed according to system stability rule, the SOH estimation reliability and stability can be ensured without having to involving itself in tireless learning and experiencing in conventional battery management system.

Furthermore, as the battery SOH estimation apparatus of the present disclosure is also capable of estimating the SOC of a battery, the SOC and SOH of a battery can be estimated in synchronization.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A battery state of health (SOH) estimation apparatus, comprising:
a measurement unit, connected to an output end of a battery, provided for measuring a working current, a working voltage and a working temperature of the battery and thus outputting a current signal, a voltage signal and a temperature signal accordingly and correspondingly;
an observer unit, electrically connected to the measurement unit, for observing voltages at the output end and RC parallel circuits of the battery while correspondingly outputting a voltage-error signal relating to the output end, a battery RC internal voltage signal, and a differential current signal;
an adaptive algorithm unit, electrically connected to the measurement, for outputting at least one parameter updating signal so as to enable the updating of corresponding parameters of the battery;
an internal voltage estimation unit, electrically connected to the measurement unit, the observer unit and the adaptive algorithm unit, for estimating internal voltages of the RC parallel circuits while correspondingly outputting an internal voltage estimation signal;
an open-circuit voltage (OCV) estimation unit, electrically connected to the observer unit, for estimating a static open-circuit voltage of the battery while correspondingly outputting an open-circuit voltage signal;
a state-of-health (SOH) estimation unit, electrically connected to the measurement unit, the observer unit and the adaptive algorithm unit, for estimating an SOH of the battery while correspondingly outputting a battery SOH signal; and
a state-of-charge (SOC) estimation unit, electrically connected to the measurement unit, OCV estimation unit and the SOH estimation unit, for estimating a SOC of the battery.

2. The apparatus of claim 1, wherein the current signal and the voltage signal are transmitted to the observer unit, the adaptive algorithm unit and the internal voltage estimation unit so as to be provided for an operation of SOC estimation, while the temperature signal is transmitted to the SOH estimation unit so as to be provided for an operation of SOH estimation.

3. The apparatus of claim 1, wherein the observer unit is enabled to perform a voltage observation operation basing upon a first-order differential state equation relating to the battery.

4. The apparatus of claim 1, wherein the observer unit is enabled to receive the current signal, the voltage signal, the at least one parameter updating signal and the open-circuit voltage signal while performing a calculation basing upon those received signals so as to obtain the voltage-error signal relating to the output end, a voltage estimation signal relating to the output end, and the differential current signal.

5. The apparatus of claim 1, wherein the adaptive algorithm unit is enabled to observe and measure the current signal, the voltage signal, the open-circuit voltage signal, the voltage-error signal, the battery RC internal voltage signal and the differential current signal so as to perform the updating of corresponding parameters of the battery accordingly.

6. The apparatus of claim 1, wherein the at least one parameter updating signal from the adaptive algorithm unit is transmitted to the internal voltage estimation unit where it is used in an estimation operation and also being further transmitted to the SOH estimation unit for SOH estimation.

7. The apparatus of claim 1, wherein the internal voltage estimation unit is enabled to received the current signal, the voltage signal, the at least one parameter updating signal and the open-circuit voltage signal; and further the internal voltage estimation unit is enabled to use a signal of series resistance parameter to perform an internal voltage estimation upon a RC parallel circuit in the battery by comparing the result of the internal voltage estimation and an true voltage value relating to the converged signal of series resistance parameter, so as to speed up the parameter convergence of the RC parallel circuit.

8. The apparatus of claim 1, wherein the internal voltage estimation signal from the internal voltage estimation unit is transmitted to the adaptive algorithm unit for parameter updating.

9. The apparatus of claim 1, wherein the OCV estimation unit is enabled to use a database containing information relating to the relationship between battery SOC and a battery OCV, and the SOC of the battery obtained from the SOC estimation unit in a calculation for obtaining the open-circuit voltage signal.

10. The apparatus of claim 1, wherein the open-circuit voltage signal from the OCV estimation unit is transmitted to the observer unit, the adaptive algorithm unit and the internal voltage estimation unit.

11. The apparatus of claim 1, wherein the estimating of the SOH of the batter performed in the SOH estimation unit is based upon the temperature signal, the at least one parameter updating signal, and a database containing information relating to the relationship between battery SOH and the internal resistance variation of battery.

12. The apparatus of claim 1, wherein the SOH estimation unit is coupled to a conversion unit for perform a conversion operation upon the battery SOH signal; and the conversion operation is an operation selected from the group consisting of: a unit conversion and a analog-to-digital conversion.

13. The apparatus of claim 12, wherein the conversion unit is further coupled to a device selected from the group consisting of: a battery management system (BMS) and a display device, where the converted battery SOH signal is displayed.

14. The apparatus of claim 1, wherein the result of the SOC estimation from the SOC estimation unit is transmitted to the OCV estimation unit for open-circuit voltage estimation.

15. A battery state of health (SOH) estimation apparatus, comprising:
a measurement unit, connected to an output end of a battery, provided for measuring a working current, a working voltage and a working temperature of the battery and thus outputting a current signal, a voltage signal and a temperature signal accordingly and correspondingly;
an observer unit, electrically connected to the measurement unit, for observing voltages at the output end and RC parallel circuits of the battery while correspondingly outputting a battery RC internal voltage signal, and a differential current signal;
an adaptive algorithm unit, electrically connected to the measurement, for outputting at least one parameter updating signal so as to enable the updating of corresponding parameters of the battery;
an open-circuit voltage (OCV) estimation unit, electrically connected to the measurement unit, observer unit and the adaptive algorithm unit, for estimating a static open-circuit voltage of the battery while correspondingly outputting an open-circuit voltage signal; and
a state-of-health (SOH) estimation unit, electrically connected to the measurement unit and the OCV estimation unit, for estimating an SOH of the battery while correspondingly outputting a battery SOH signal.

16. The apparatus of claim 15, wherein the current signal and the voltage signal are transmitted to the observer unit and the adaptive algorithm unit so as to be provided for an operation of SOC estimation, while the temperature signal is transmitted to the SOH estimation unit so as to be provided for an operation of SOH estimation.

17. The apparatus of claim 15, wherein the observer unit is enabled to perform a voltage observation operation basing upon a first-order differential state equation relating to the battery.

18. The apparatus of claim 15, wherein the observer unit is enabled to receive the current signal, the voltage signal, and the at least one parameter updating signal while performing a calculation basing upon those received signals so as to obtain the voltage estimation signal relating to the output end, and the differential current signal.

19. The apparatus of claim 15, wherein the adaptive algorithm unit is enabled to observe and measure the current signal, the voltage signal, the voltage estimation signal relating to the output end and the differential current signal so as to perform the updating of corresponding parameters of the battery accordingly.

20. The apparatus of claim 15, wherein the at least one parameter updating signal from the adaptive algorithm unit is transmitted to the observer unit, the OCV estimation unit and the SOH estimation unit to be used in a SOC estimation operation and a SOH estimation operation performed respectively in the OCV estimation unit and the SOH estimation unit.

21. The apparatus of claim 15, wherein the OCV estimation unit is enabled to use the temperature signal from the measurement unit, the at least one parameter updating signal form the adaptive algorithm unit in a calculation for obtaining the open-circuit voltage signal.

22. The apparatus of claim 15, wherein the OCV estimation unit is further connected to a first conversion unit; and the first conversion unit is used for performing a conversion operation selected from the group consisting of: a unit conversion and analog-to-digital conversion, and then consulting to an built-in lookup table for obtaining the battery SOC signal.

23. The apparatus of claim 22, wherein the first conversion unit is further coupled to a device selected from the group consisting of: a battery management system (BMS) and a display device, where the battery SOC signal is displayed.

24. The apparatus of claim 15, wherein the estimating of the SOH of the batter performed in the SOH estimation unit is based upon the temperature signal, the at least one parameter updating signal, and a database containing information relating to the relationship between battery SOH and the variation of battery internal voltages.

25. The apparatus of claim 15, wherein the SOH estimation unit is coupled to a second conversion unit for perform a conversion operation upon the battery SOH signal; and the conversion operation is an operation selected from the group consisting of: a unit conversion and a analog-to-digital conversion.

26. The apparatus of claim 25, wherein the second conversion unit is further coupled to a device selected from the group consisting of: a battery management system (BMS) and a display device, where the converted battery SOH signal is displayed.
